(19) United States
(12) Patent Application Publication
(10) Pub. No.: US 2004/0234653 A1
(43) Pub. Date: Nov. 25, 2004

(54) Susceptor tray and mirowavable dough products

(76) Inventors: Paul A. Cogley, Chicago, IL (US); Keith E. Petrofsky, Round Lake, IL (US); Steven P. Greiner, Mundehein, IL (US); Amy L. Hewitt, Buffalo Grove, IL (US); Uraiwan Tangprasertchai, Inverness, IL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 10/443,252

(22) Filed: May 22, 2003

(51) Int. Cl. A23B 4/00

(52) U.S. Cl. 426/107

(57) ABSTRACT

A susceptor tray has a susceptor surface of a platform positioned above a downwardly extending portion that has sidewall functions and that traps heated vapor within an open surface defined by the susceptor tray. A kit of the susceptor tray and a dough-containing food product has a storage mode which permits the food product to be stored within the open volume and out of contact with the susceptor surface. The extending portion preferably includes apertures to permit controlled dissipation of heated vapor from out of the open volume during cooking within a microwave oven.

### FIELD OF THE INVENTION

The present invention generally relates to improvements in connection with microwaving of dough-containing food products. More particularly, the invention relates to enhancements within the microwaving context which includes the use of a susceptor tray. The invention is particularly well suited for a dough product having a substantial crust volume which is to be subjected to microwave energy in order to cook or otherwise heat the dough so as to render it palatable and ready for serving and consumption.

### BACKGROUND OF THE INVENTION

Food products which require a minimum amount of consumer preparation and are quick to prepare are common items on grocery store shelves, in refrigerated displays or in freezer cases. Included in these are food products which traditionally are served hot or warm and include a heating step during the course of their preparation for consumption. Included in these types of food products are ones which incorporate a substantial volume of dough or batter which is formed into a product having a crusty surface. Such food products include those which are or have bread or crust components. Products of this general type include hot sandwiches, pocket-type food products, wraps, pizzas, dumplings, pies, breads and rolls.

A substantial problem which must be addressed in preparing successful dough-containing food products such as those of these types arises when dough or batter products are subjected to microwave energy in order to cook and/or heat the food product. Problems in this general area have been recognized in many forums. Included is patent art such as Ottenberg U.S. Pat. No. 4,463,020, Meraj et al. U.S. Pat. No. 4,761,290, Cochran et al. U.S. Pat. No. 4,885,180, Huang et al. U.S. Pat. No. 5,035,904, King et al. U.S. Pat. No. 6,156,356, Paulucci U.S. Pat. No. 6,168,812 and McPherson et al. U.S. Published Patent Application No. 2002/0064586. Each of these is incorporated hereinto by reference. These references include proposals for formulating the dough or batter in a way that avoids or minimizes various negative impacts which are thought to be caused by the nature of microwave heating.

For centuries, the dough-making art has been based upon placing the dough to be baked or heated within an area providing primarily conduction heating. Generally, this approach cooks or heats through direct surface heating and drying effects of heated air surrounding the food being prepared. Contrary to these often called “conventional” approaches, applying microwave energy energizes polar and ionic molecules tending to result in heat generation. While the heating effects of such microwave energy depend on many factors, including shape, size, thickness and composition of the food product, there tends to be a heating from the inside out while product surface temperatures remain relatively low due to evaporative cooling and low microwave cavity temperatures. In many situations, this heating is much more rapid along edge areas than it is in central areas of food products having somewhat uniform thickness, such as sheet pizzas. In an effort to achieve uniform cooking, unpalatable characteristics such as toughness and a leathery texture often can develop. Sometimes, these negative texture attributes develop in some areas of the food product but not in others.

Contributing to reduced palatability of microwaved dough-containing food products is the difference in drying action when the same dough formulation is subjected to external heat as in a conventional oven when compared with heating achieved by the application of microwave energy to the food product. There is a tendency for less uniform liquid removal when a food product is subjected to microwave energy, especially when comparing same with conventional oven cooking or heating. Microwaved food products can exhibit undesirable soggy texture, typically in some areas of the food product but not in others.

This background illustrates problems faced when attempting to formulate dough or batter products that are intended to be cooked, baked or heated within a microwave oven. Some or all of the food product being heated can have a variety of palatability issues, including those caused by having excess moisture within frozen food products, whether it be a dough component or another component such as a topping or filling. Such can result in excess softness and/or sogginess. All or some of the food product can become overexposed to microwave energy, often resulting in a tough or leathery consistency. These microwave issues can include having the crumb or the dough component take on a rubbery and/or gummy consistency. In general, a leathery crust becomes harder to chew and is not easily or pleasantly masticated.

The art, as generally represented by the patent art noted above, has made substantial strides in addressing these types of problems. This includes the dough formulation approaches discussed in each. Art such as Paulucci identified above propose susceptor sheet use. Other art in this general category includes several different variations on susceptor sheeting in an effort to solve this problem. Included are the following, each being incorporated by reference hereinto: Swiontek U.S. Pat. No. 4,960,598, DeRienzo U.S. Pat. No. 5,223,685, Gics U.S. Pat. No. 5,565,228, Sadek et al. U.S. Pat. No. 6,359,272, Cole et al. U.S. Pat. No. 6,414,290, and Aronsson et al. U.S. Pat. No. 6,476,368.

Art of this type recognizes that microwave cooking or heating of generally sheet-like food products is believed to be enhanced by providing a microwave susceptor material, such as aluminum, on a surface on which the food product rests. When microwaves strike the microwave susceptor material, higher temperature heating results. This heat generation is believed to be useful in ensuring thorough cooking of the underside of the food product in an effort to address issues such as soggy pizza crusts when microwave heated. For example, U.S. Pat. No. 6,476,368 teaches providing a susceptor panel for heating garnished flat dough in microwave ovens. A plurality of apertures are provided in the susceptor panel for forming gas and microwave energy permeable areas which are taught to be positioned at specific locations on the susceptor panel. U.S. Pat. No. 6,414,290 proposes the use of an imperforate susceptor plate which has a pattern of microwave-transparent areas interspersed within the microwave susceptor surface. This is said to enhance crust browning.

U.S. Pat. No. 5,223,685 shows an elevated microwave cooking platform. The cooking surface of this platform has a series of larger openings intended to provide direct contact between food supported on the platform and air beneath the platform. Support legs elevate the platform and the food thereon so as to provide more room beneath the platform and the food supported on the platform. The support legs are widely spaced apart. Air circulating beneath the platform in between the widely spaced legs evaporates moisture from this air.

Approaches of the art thus far have not fully succeeded in providing microwave heated, cooked or baked dough-containing products that exhibit organoleptic properties and superior palatability for the same type of food product when it is heated, cooked or baked within a conventional oven which applies cooking and drying heat to the outside of the food product. The objective of parity between microwaved food products and the same type of product cooked by conventional oven approaches has not been achieved heretofore. This is especially true for frozen pizzas which are intended to be heated by microwave energy such as that put forth by a household microwave oven.

As a convenience feature, it often can be desirable to provide susceptor devices that are easy to use, inexpensive and disposable and do not substantially add to the bulk of the food product as packaged for distribution. It would be desirable to have a combination or kit which is a self-contained assembly of the food product and of the tools needed to properly heat, cook or bake that very food product within a microwave oven including those designed for household use.

### SUMMARY OF THE INVENTION

In accordance with the present invention, a microwave susceptor tray is provided which has a heating surface that is sized and shaped to accommodate a dough-containing food product during a heating mode. The susceptor tray further includes an extending portion that cooperates with other surfaces of the susceptor tray to define a tray volume. This tray volume has at least two purposes, one during a packaged, pre-cooking mode and another during a cooking mode. In the former, the tray volume provides a compact packaging, distribution and storage spaced for the dough-containing food product when the food product and tray, which are packaged as a unitary consumer-purchasable product. During the cooking mode, this tray volume of the susceptor tray functions to hold a source of most heated air directly beneath the food product being cooked or heated, thereby facilitating the advantageous microwave cooking effect of the invention.

In an aspect of the invention, the susceptor tray is provided such that a dough-containing food product is readily stored within its defined inside volume while, when unpackaged, providing a platform for spacing the food product from the floor of the microwave oven in order to facilitate product heating, cooking or baking.

In a preferred aspect of the invention, one or more of the features discussed herein are combined with one or more openings that allow for material that is driven off from the food product during cooking to pass into the tray volume of the susceptor tray and be held there for a desired period of time in order to thereby enhance heating of the food product during exposure to microwave energy.

In a further aspect of the invention which can, if desired, be used in combination with the other features disclosed herein, the extending portion is in the nature of a sidewall or skirt that includes one or more apertures which allow for controlled escape from the tray volume of vapor or other material driven off from the food product during cooking.

In another aspect of the invention, any of these features can be combined with means for selectively varying the extent of porosity of the extending portion or sidewall in order to vary the extent of escape that is permitted from out of the tray volume location. Such selective varying means can be used by the food preparer or ultimate consumer in order to customize the susceptor tray.

It is a general object of the present invention to provide improved packaged microwaveable dough-containing food products. Another general object of the invention is to provide a microwave susceptor tray that functions both as a packaging element and as a cooking platform which provides an underside volume that enhances heating when a food product is positioned on the platform and subjected to microwave energy. Another general object of the invention, which can be combined with other features of the invention, is to provide a packaged microwave dough-containing food product kit which includes the food product within a susceptor tray that itself is within an overwrap member.

In an important aspect of this invention, the features of the invention enhance the value of convenience food products which are designed to be cooked, baked or heated by microwave energy. A primary aspect of this enhancement is that the thus prepared food item has organoleptic and palatability characteristics which are not statistically distinguishable from like food products that are cooked, baked or heated by conventional heat-generating oven such as one using convection principles.

These and other aspects, objects, features and advantages of the present invention, including the various features used in various combinations, will be apparent from and clearly understood through a consideration of the following detailed description.

### BRIEF DESCRIPTION OF THE DRAWINGS

In the course of this description, reference will be made to the attached drawings, wherein:

FIG. 1 is an exploded perspective view showing an embodiment of the invention which incorporates an overwrap member in combination with a tray and packaged food product positioned within its interior volume;

FIG. 2 is a top perspective view showing the susceptor tray and the food product of FIG. 1 in their combined cooking mode and as oriented within a microwave oven;

FIG. 3 is a cross-sectional view through FIG. 2;

FIG. 4 is a top plan view of an embodiment of a susceptor tray according to the invention;

FIG. 5 is a bottom plan view of the susceptor tray of FIG. 4;

FIG. 6 is a side elevational view of the susceptor tray of FIG. 4, showing a food product positioned thereon;

FIG. 7 is an enlarged cross-sectional view through and end portion of FIG. 6;

FIG. 8 is a perspective view of another embodiment of a susceptor tray according to the invention;

FIG. 9 is a perspective view of a further embodiment of the susceptor tray according to the invention;

FIG. 10 is a top plan view of an additional embodiment of a susceptor tray according to the invention;

FIG. 11 is a side elevational view of yet a further embodiment of susceptor tray according to the invention;

FIG. 12 is a bar graph representation of data comparing firmness/crispness of a pizza crust with and without a susceptor according to the invention;

FIG. 13 is a bar graph representation of data comparing firmness/crispness of a pizza crust with and without a susceptor according to the invention, together with corresponding data for an oven-baked pizza;

FIG. 14 is a plot of time versus temperature at four different locations during cooking of a frozen pizza on a susceptor without sidewall venting;

FIG. 15 is a plot of time versus temperature as in FIG. 14 while using a susceptor having sidewall venting;

FIG. 16 provides bar graph representations of data comparing firmness/crispness of crusts of pizzas, including data generated with and without platform porosity; and

FIG. 17 provides bar graph representations of data comparing firmness/crispness of crusts of pizzas, including data generated with varying sidewall porosity.

### DESCRIPTION OF THE PREFERRED EMBODIMENTS

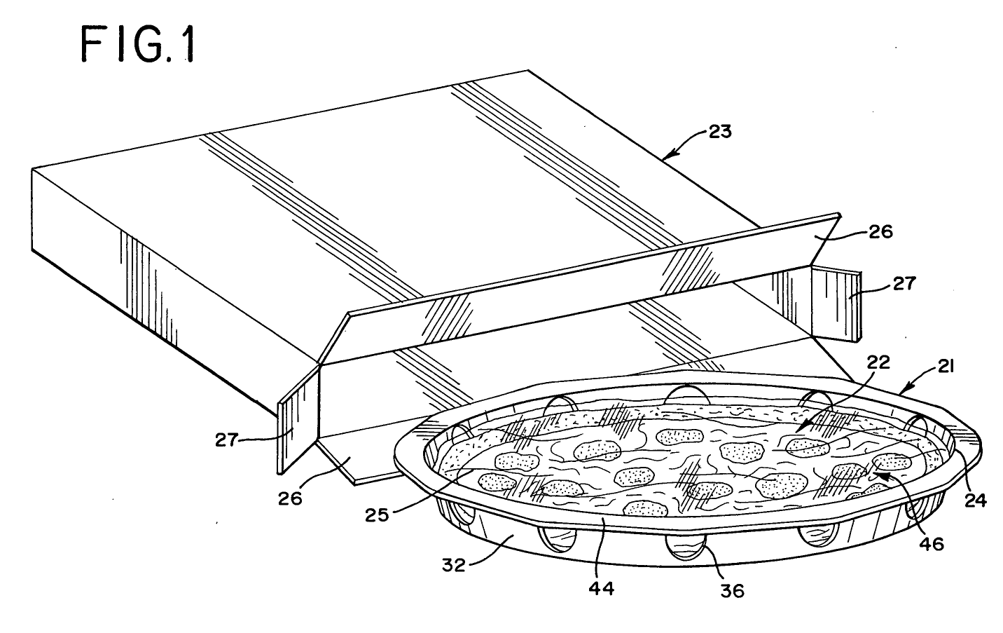

FIG. 1 illustrates an embodiment of the invention which includes three principal components. A microwave susceptor tray is generally designated as 21. A dough-containing food product is generally designated as 22. An example of secondary packaging is generally designated as 23. It will be noted that the food product 22 fits within and is accommodated by the tray 21. Inasmuch as these products are to be sold commercially, secondary packaging typically would be included so as to provide adequate surface area for required labeling, for product identification, manufacturer information, and marketing information, for example. Secondary packaging also provides additional barrier protection for the food product, as well as tamper evidence protection.

Suitable secondary packaging can take the form of a somewhat rigid carton or box as generally shown in FIG. 1. Such a carton 23 is made of paperboard, optionally treated as desired for protection, such as enhanced light and moisture-barrier properties or other reasons for external boxing, including product protection, reduced oxygen transmission and the like. Treatment can include one or more polymer layers. The secondary packaging can be for single or multiple products.

When it is deemed that, in appropriate commercial settings, boxing of individual or multiple products is neither desired nor required, other secondary packaging members can be used. This includes a flexible wrapping which totally encloses the susceptor tray 21, or multiple susceptor trays 21. Closely conforming secondary packaging could thus be used. The secondary packaging also could take the form of an envelope which encloses the susceptor tray 21. A further approach could be the use of sheeting which engages a peripheral edge 24 of the susceptor tray, thereby sealing the dough-containing food product 22 within the susceptor tray 21. It will be appreciated that other approaches can be devised for performing the secondary packaging or functions noted above.

The version of the invention which is shown in FIG. 1 further includes a protective wrapping 25 for the dough-containing food product itself. Such protective wrappings are well-known in the art. They are useful in maintaining the integrity of the dough-containing food product, which may include garnishes, toppings or the like which could be damaged or separated from the food product during normal handling. A protective wrapping 25 also can serve the purpose of providing a convenient location for cooking, baking or heating instructions, as well as provide product identification and labeling functions to the extent these functions would not be already provided by any secondary packaging, particularly in those situations where secondary packaging is not required or used.

It will be appreciated that, with the embodiment shown in FIG. 1, the consumer or food preparer will purchase the product with the dough-containing food product within the otherwise open volume of the susceptor tray. In this way, the susceptor tray provides good protection for the dough-containing food product. Ideally, the entirety of the dough-containing food product (or a major portion of the entire food product) lies below, or at least no higher than, the peripheral edge 24 of the susceptor tray. This susceptor tray and dough-containing food product combination is accommodated by the secondary packaging when provided, such as the illustrated carton 23. In the case of the illustrated carton 23, its end flaps 26, 27 are closed and sealed so that the susceptor tray and food product are totally within the carton. With this illustrated embodiment, this is the form in which the consumer or food preparer will purchase the product. When this is a frozen product, this packaged product will be stored in an appropriate freezer case. Refrigerated or shelf stable products would be stored and/or displayed in suitable merchandizing equipment or shelving.

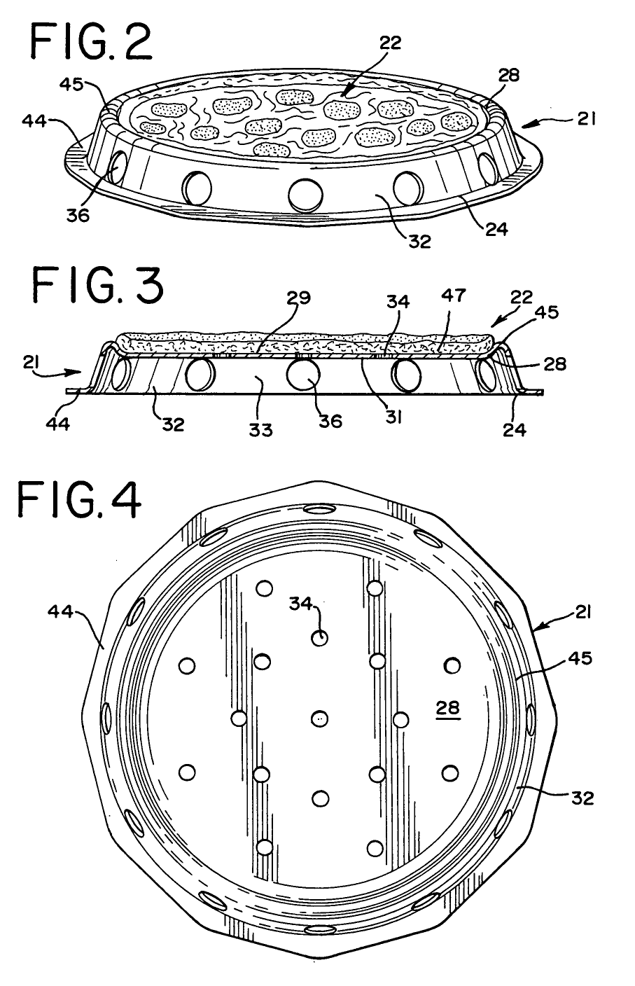

Microwave susceptor tray 21 includes a susceptor surface 28, as seen for example in FIG. 2, FIG. 3 and FIG. 4. It is important to note that this susceptor surface is on an outwardly facing face 29 of the generally planar portion of the susceptor tray. It will be appreciated that the terms generally planar or planar can encompass surfaces having depressions, raised portions, texture, holes, perforations and the like, and is not intended to mean planar in a strict geometric sense. As is generally known, susceptor material contributes to browning of dough products such as pizza crusts. The susceptor material causes localized heating which develops temperatures that are more elevated than other non-susceptor areas. Such elevated temperatures promote Maillard reactions in the crust or other dough material where contact occurs between same and the susceptor material. This effect is less likely to be observed in areas without direct contact of this type, such as at openings where no susceptor material is present.

The opposite face of this generally planar portion is an inwardly facing face 31. This face 31, together with an extending portion or component 32, define the volume 33 of the microwave susceptor tray 21. This tray volume preferably is adequate to totally accommodate the dough-containing food product 22 when in the packaged, non-cooking mode, as generally discussed above. The tray volume also functions to enhance cooking and/or moisture retention, and often also cooking uniformity, at times in cooperation with porosity which can be provided in the downwardly depending extending portion or sidewall 32.

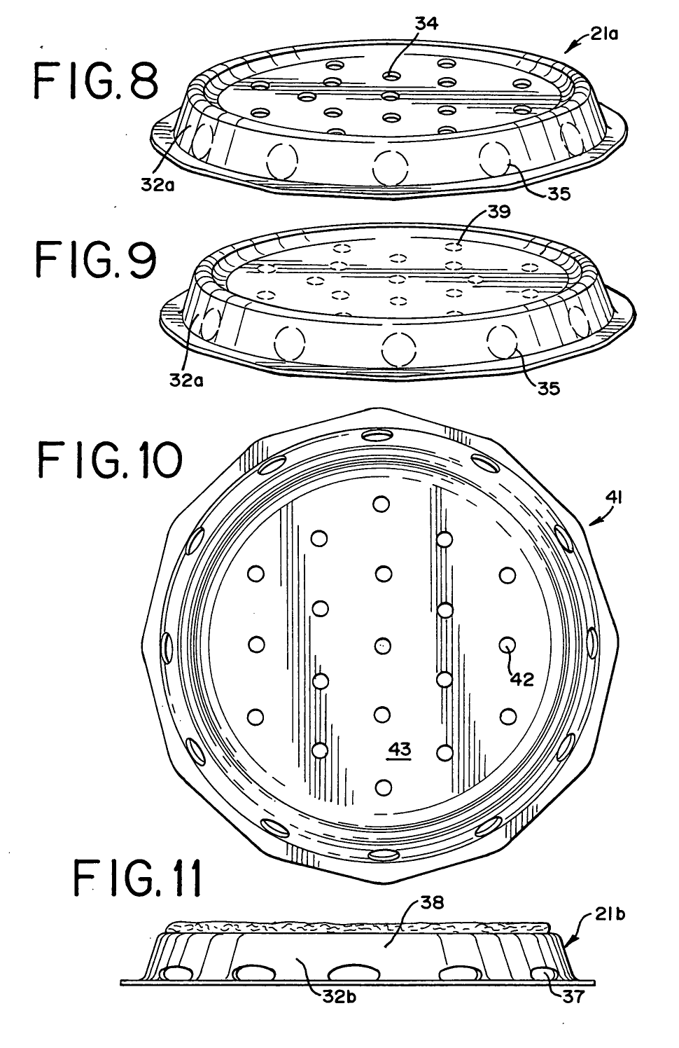

In the illustrated embodiment of FIG. 1 through FIG. 7, this tray volume location 33 is generally equal to the volume defined by a truncated cone which can perhaps best be appreciated from FIG. 3. The extent and confining nature of this volume play an important role in enhanced microwave heating performance achieved by the invention. Important to such performance is the combination of the size of this confined tray volume with its location under the microwave cooking surface provided by the susceptor surface 28 of the outside facing face 29 of the generally planar portion or component of the microwave susceptor tray. The importance of this combination is discussed in greater detail elsewhere herein.

With further reference to the generally planar portion of the microwave susceptor tray 21, a plurality of openings 34 preferably are included which provide locations of access between the outwardly facing face 29 and the tray volume location 33. Openings 34 thus provide means for passing byproduct material from the baking, cooking or heating of the dough-containing food product through the generally planar tray portion and into the tray volume location 33. Materials which are especially important in this regard are vapors which are given off by the food product during heating. For example, the openings 34 facilitate dissipation of water vapor generated during baking, heating or cooking, especially of a frozen food product, which could otherwise lead to development of a soggy bottom surface of the food product.

Furthermore, material, especially steam, driven off from the food product which pass through the holes 34 help to provide a medium for enhanced heating or cooking action within the confined volume below the susceptor surface. In essence, vapors or other food byproduct materials provide a heated medium within the susceptor tray volume. That heated medium provides a warm air or a convection heating which approximates the type of heating action provided by a non-microwave, conventional oven. It also provides a “steam effect” that further heats the bottom of the crust to give it a crispy bottom texture and an even, brown color. This steam is preferably controlled to keep the proper amount of moisture in the food product in order to prevent the crust from becoming too hot and dehydrated, resulting in an overcooked crust that can become too hard, tough and chewy.

This steam effect assists in heating, baking, or cooking the food product while providing an additional, moist heat source from below the food product, thereby cooperating with the microwave energy heating in order to provide enhanced heating action according to the invention, which results in food products having palatability and organoleptic properties which mimic those of like food products which are cooked, baked or heated within a conventional, non-microwave oven.

The correct elevation and the surface area of the susceptor tray make up the volume underneath the susceptor planar surface, which is coupled with the correct number and size of apertures in the susceptor extending portion to allow the needed amount of moisture or steam to leave the dough yet not dry it out. To control the right amount of steam trapped beneath tray, side vent apertures may be added to include outside venting of steam. By providing side vent perforations consumers can customize of the susceptor tray to their preference or to improve cooking in a particular microwave oven.

More particularly, the extent of supplemental heating from below can be varied or tailored according to the make-up of the extending portion 32 of the microwave susceptor tray. In one embodiment, the extending portion can be imperforate. This is generally illustrated by the embodiment of FIG. 8. In that embodiment, a microwave susceptor tray 21a has an extending portion 32a that can have no passages therethrough. Preferably, in this embodiment, one or more perforated areas 35 are positioned around the extending portion 32a. The consumer then has the ability to easily adjust the heat applied by the vapors and other materials which might be present and which are heated within this tray volume. By removing one or more parts of the extending portion 32a which are defined by the perforated areas 35, the consumer provides a passage for such heated vapors out of the susceptor tray volume. Generally speaking, the greater the number of perforated areas which are opened by the consumer, the less heat will develop and remain within the susceptor tray internal volume, and the less will be the heating afforded by the from-below heat source which is provided in accordance with the invention.

In the embodiment which is illustrated in FIG. 1 through FIG. 7, the susceptor tray, as manufactured has pre-selected what is in effect the porosity of the extending portion 32. A plurality of apertures 36 are positioned through the extending portion 32. This provides an as-manufactured porosity deemed to be suitable for the particular food product and for a typical household microwave oven. Supplying an extending portion 32a having perforated areas 35 allows the consumer to account for any differences in the operation of individual microwave ovens and for consumer taste preferences. For example, if a particular microwave oven heats more efficiently than the norm, creating more sidewall porosity by removing one or more perforated areas 35 will offset somewhat the supplemental heating achieved by the susceptor internal volume heat sink within that oven. Similarly, if a consumer cooking preferences warrant, increasing the side porosity by removing one or more perforated areas 35 will provide a reduced steam effect.

If desired, both apertures 36 and perforated areas 35 can be provided in the extending portion or sidewall of the microwave susceptor tray. This would ensure a minimum porosity level as provided when manufactured, while still affording the consumer the ability to increase the porosity for reasons generally outlined above. The manner by which porosity is provided and/or varied is not limited to circular openings or apertures as specifically shown in the drawings, although the circular shape tends to have advantages of efficiency in manufacturing and ease of removal by the consumer.

Additionally, the precise shape of the extending portion 32, 32a which is shown in the drawings can be varied as desired. The illustrated skirt-like truncated cone sidewall tends to be easy and inexpensive to manufacture but can be varied as desired. It is important that the extending portion provide the function of elevating the susceptor surface above the floor of the microwave oven, combined with the function of providing a substantial barrier to the escape of vapor and other byproduct material from heating the food product so that same will remain within the susceptor tray volume 33 for a length of time that significantly enhances the heating, cooking or baking function as described herein.

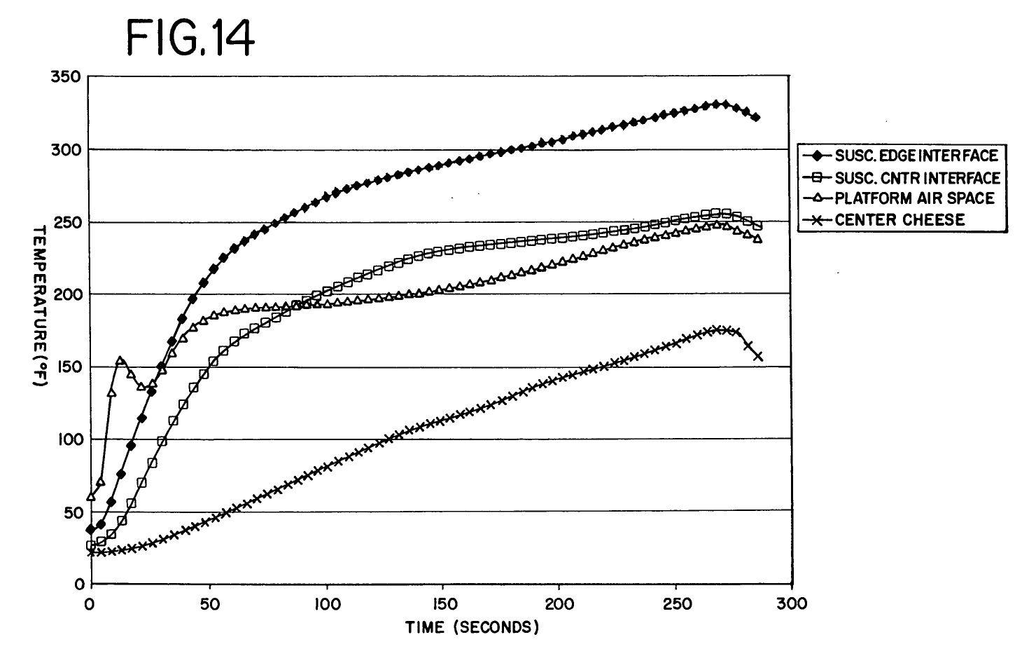

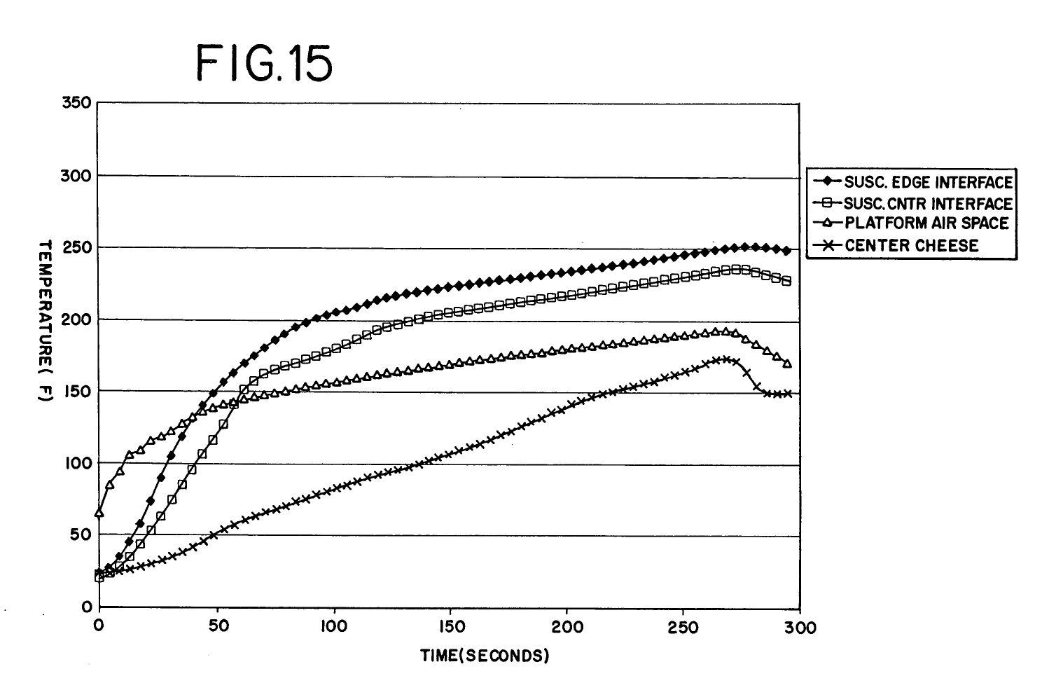

Variations in the porosity features also are possible. Porosity can vary from as much as 60 percent to as low as 5 percent and below. For other uses, porosity can be as high as about 50%. In other uses, porosity is as high as about 30%. For still other uses, the porosity can be as great as 25%; for others only as great as 15%; and for others as great as 10%. A preferred range for certain embodiments is between about 18 and about 20 percent of the sidewall. Sidewall venting releases moisture and heat to enhance center texture and prevent edge overheating. This venting has the greatest effect on pizza crust edge temperature as shown in FIG. 14 and Example 3. For products that are to be cooked for a shorter time than a pizza, or to address particular consumer preferences, it is usually beneficial to have sidewall porosity in the lower portion of the porosity range in order to trap heat more effectively. Having the sidewall porosity in the higher portion of the range is usually beneficial when longer cook times are desired for a particular type of product or to address consumer taste preferences.

FIG. 11 shows a susceptor tray 21b which has its porosity concentrated near the outside edge or bottom of its extending portion 32b. Its aperture or apertures 37 are not circular, but are longer in the horizontal direction than in the generally vertical direction, thereby making possible the positioning of the aperture or apertures 37 very close to the floor of the microwave oven, when the susceptor tray is in use heating the food product. This arrangement has the benefit of maintaining a substantially imperforate peripheral sidewall portion. In the embodiment illustrated in FIG. 11, this imperforate peripheral sidewall portion is illustrated at 38. It will be noted that in other embodiments, an imperforate peripheral sidewall also is provided, but it is much less extensive in its height when compared with this FIG. 11 embodiment.

Typically, the susceptor trays will be made of paperboard material, with the exception of the susceptor surface itself. It is possible that more of the outside surface of the paperboard than the generally planar area can be coated with susceptor material. For example, it typically can be less costly to manufacture a tray made of paperboard which is substantially completely covered with susceptor material, on one or both sides or surfaces thereof.

Due to heat build-up within the tray volume, the apertures 36 in the extending portion of the tray, especially when same is in the nature of a sidewall, help to prevent generally negative developments with respect to the tray. Excessive heat build-up within this volume could result in scorching or burning of the paperboard and/or wall delamination, such as random separation of a polymer coating from the paperboard, all potentially caused by excessive localized heat build-up. Providing somewhat equally spaced means for heat egress from the susceptor tray volume 33 addresses such potential problems. Furthermore, apertures in the extending portion, especially when same is in the nature of a sidewall, function has a location for easy and sure grasping of the tray and thus of the food product, such as during removal from the microwave oven.

Although only circular susceptor tray platforms or planar tray portions are shown, it will be appreciated that other shapes are possible. Usually, the shape should correspond to or be complementary with the shape of the food product being heated, cooked or baked. Exemplary shapes include squares, rectangles, triangles, other polygons, and ellipses. Typical susceptor tray construction involves pressing the tray shape from a flat piece of polymer-coated paperboard in order to define the overall shape of the susceptor tray. The susceptor material application, hole formation and preformation formation are carried out in accordance with the principals known or to be known in the art. Optionally, trays can be made of component parts which are assembled.

FIG. 9 shows an embodiment in which perforated areas 39 are provided within the generally planar portion of the susceptor tray of that embodiment. These provide the ability for the consumer to adjust the extent of passage through the generally planar, typically horizontal surface. In most instances, openings 34, such as shown in FIG. 8, will be designed by the manufacturer to provide optimum heating, cooking or baking for the particular food product that is intended to be packaged with the product. However, providing perforated areas 39, either alone or what would typically be in combination with openings 34, has the advantage of providing consumers with means for easily modifying both the degree of passage through the generally horizontal panel and the amount of susceptor material that is in engagement with the bottom of the dough-containing food product.

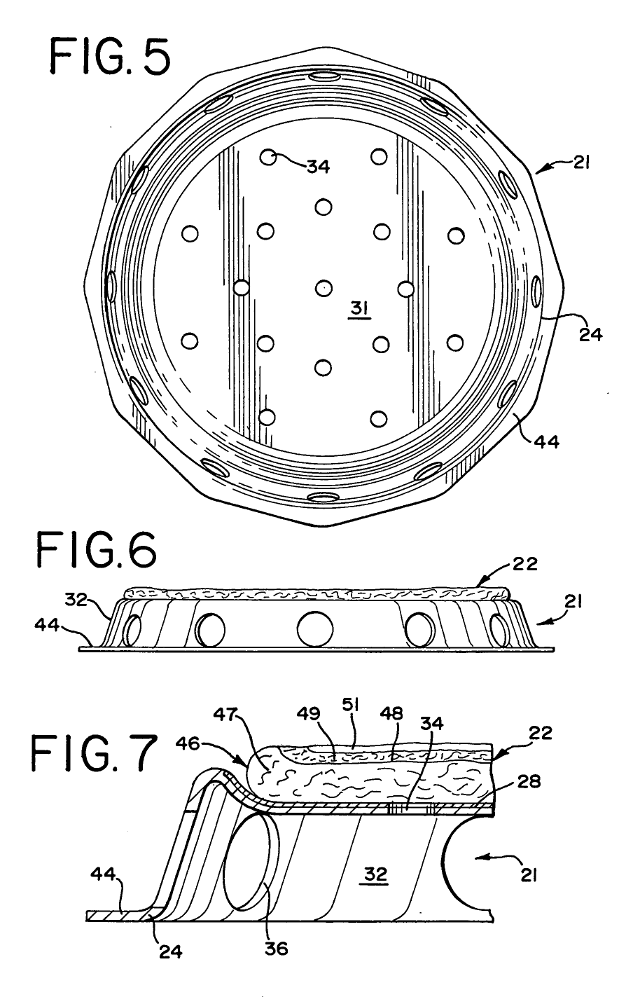

Referring further to the openings provided by the susceptor tray manufacturer or by the consumer, it is generally preferred that such openings be approximately evenly spaced along the susceptor surface. In a broad manner of speaking, the spacing of openings 34 shown in FIG. 4 and FIG. 5 provides a somewhat uniform array. This particular arrangement is of concentric circles of openings 34, the concentric circles being somewhat evenly spaced from each other.

An example of more precise uniform spacing is illustrated by the susceptor tray 41 depicted in FIG. 10. This microwave susceptor tray 41 has an array of openings 42 through susceptor surface 43 and the generally planar portion which is a part in this embodiment. In this arrangement, each opening is substantially equidistant from each opening which is adjacent to it.

Spacing of openings through the generally planar portion of a microwave susceptor tray affects certain functions of the tray. Clearly, the greater the porosity, both in terms of opening size and frequency, the greater the ease of transmission into the susceptor tray volume of vapor and other possible byproduct materials generated by food product heating, cooking or baking. The generally uniform spacing which is illustrated helps to assure that this passage through the typically horizontal platform is not concentrated at any particular location of the food product.

In addition, the openings represent the absence of susceptor material and the attendant reduction in heating which is attributable to microwave energy impingement upon the susceptor material. Generally speaking, where susceptor material is not present, the browning effects of the microwave energy are reduced in intensity. Relatively small sized and relatively evenly spaced openings help to ensure that there will be minimal development of noticeable light-colored areas on the bottom of the food product crust. Generally, porosity exceeding 25 percent will not heat with desired effectiveness, depending upon the dough-containing food product and/or consumer preferences. For a typical paperboard-based susceptor tray greater than 15 percent porosity may not be practical to remove from a size or strength of material point of view.

When adequate moisture removal is present preventing excessive moisture condensation or collection between the susceptor and the product to be heated, the more susceptor material that is not present on the susceptor surface, the less will be the effect on browning of the food product crust due to engagement with the susceptor tray. Desirable browning typically includes avoiding susceptor material omission which is more than needed to achieve the other affects discussed herein. This is achieved without requiring added browning-promotion dough components or surface additives or coatings.

Aside from the spacing of openings in the generally planar panel of the susceptor tray, opening size also is an important consideration. This is illustrated by the following information when the openings are provided by the manufacturer and are circular. Opening diameter should range between about 3/16 inch and about ⅜ inch (between about 4.7 mm and about 9.5 mm). A preferred hole size is 0.25 inch (about 6.4 mm). Typical edge-to-edge spacing between these openings is from about 0.50 inch and about 1.25 inch (between about 13 mm and about 32 mm). It is generally preferred that this spacing be not more than about 1 inch (about 25 mm) between most openings. Generally speaking, smaller opening sizes should be accompanied by shorter spacing length between openings, for example.

It will be appreciated that the size of the volume delineated by the tray when in use within a microwave oven will depend upon the dimensions of the susceptor tray. To large degree, this volume depends upon the area of the periphery or footprint of the generally planar portion and the height of the planar portion from the floor of the microwave oven. The larger the product of this area dimension times this height dimension, the greater will be tray volume. The tray volume substantially defines the boundaries for the vapor that can be accommodated by the susceptor tray. The extent that the maximum calculated volume truly constrains the vapor will depend in part upon the porosity features of the susceptor tray as discussed elsewhere herein.

For most food products and susceptor trays, the height measurement will be between about 0.25 inch and about 1.25 inch (about 6.4 mm and about 32 mm). When the dough-containing food product 22 is a thin-to-medium crust pizza, its thickness ranges between about 0.25 inch and about 0.5 inch (between about 6 mm and about 13 mm). This illustrates how the tray volume can accommodate a typical food product in the packaged, non-cooking mode. In the case of a circular susceptor tray of the type illustrated in the drawings which is sized to accommodate a circular frozen pizza having a diameter of about 6 inches (about 15 cm), a preferred height ranges between about 0.75 inch and about 1 inch (between about 19 mm and about 25 mm).

The susceptor tray optionally can include material which extends beyond the peripheral edge 24. This can take the form of a peripheral rim 44. When provided, rim 44 functions to provide extra material in order to strengthen the extending portion of the susceptor tray, particularly if same is otherwise weakened by apertures 36 or other means to provide porosity and flow through the extending portion 32. Peripheral rim 44 typically will be generally parallel to the generally planar portion having the susceptor surface 28. As such, peripheral rim 44 can enhance the functional stability of the susceptor tray to minimize the chance of unwanted susceptor tray movement during microwaving.

In the illustrated embodiment, a raised perimeter boss 45 is at the interface between the generally planar or horizontal portion and the generally downwardly extending portion of the susceptor tray. Raised perimeter boss 45, when provided, helps to maintain the position of the dough-containing food product on the susceptor tray. Preferably, the entire bottom surface of the food product remains in contact with the susceptor material throughout the heating, cooking or baking time, except for where the openings are provided.

The figures illustrate dough-containing food products which take the form of a thin-to-medium crust circular pizza, generally designated as 46. Included is a dough layer or crust 47. The illustrated crust has a central depression 48 which extends throughout the crust except for at its periphery. Typically, one or more toppings fill this depression. In the illustrated embodiment, a sauce topping 49 has a second topping, such as of cheese material, on its surface, as generally illustrated in FIG. 7. Other toppings can be added as desired. Any of these toppings can be varied as desired in order to suit particular tastes. Subjecting the food product to microwave energy while supported by the microwave susceptor tray according to the invention results in heating, cooking or baking the crust, whether frozen, refrigerated or at room temperature and whether unbaked, partially baked or substantially fully baked, until the crust is done as desired and exhibits desired texture and crispness. Simultaneously, the topping or toppings are heated until the desired degree of cook is achieved.

The following Examples illustrate certain features and advantages of the invention in order to further illustrate the invention. The Examples are not to be considered limiting or otherwise restrictive of the invention.

### EXAMPLE 1

A plurality of pizzas were prepared. Each was a so-called cheese pizza having a crust made of a wheat flour composition having the same formulation. Each pizza had the same topping of a tomato-based sauce, which itself had cheese topping thereover. Each cheese pizza was cooked at the same elevation, namely 0.75 inch (19 mm) above the floor of the microwave oven. Each pizza was microwaved for three minutes thirty seconds in an 1100 Watt Amana microwave oven. Each was subsequently tested for firmness and crispness after removal from the microwave oven for the same length of time.

Peak force measurements were made on each pizza after 2 minutes elapsed after microwaving. The peak force application device was a TA-XT2 Texture Analyzer (Stable Micro Systems, Texture Technologies Corp). This device included a conventional unit for applying a force and measuring same in grams. This unit included a five-prong probe passing through a one-inch die. The probes were 2 mm in diameter. Upon the application of force, the probes entered and passed through the cooked pizza, and the equipment measured and reported peak force applied to achieve the same degree of penetration for each cooked pizza. With this equipment, the greater the peak force, the greater the firmness and/or crispness of the cooked pizza.

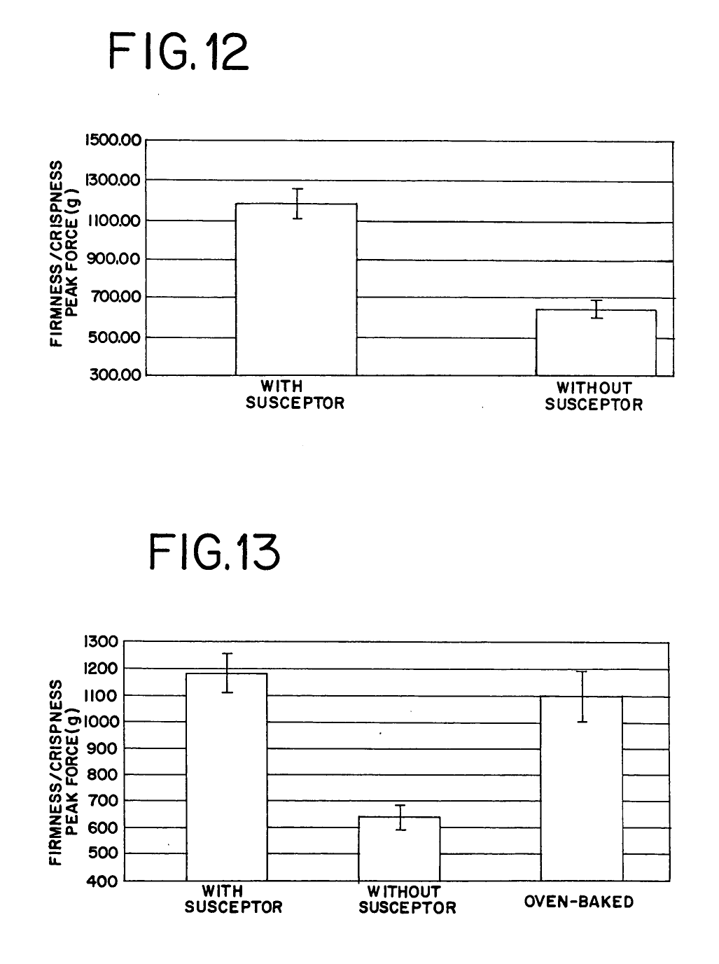

Results of this testing are graphically illustrated in FIG. 12. N=3 for each variable, there being n=5 measurements per pizza, for a total of n=15. As shown in FIG. 12, the pizzas which were cooked while supported on the susceptor in accordance with the invention had a peak force somewhat under 1200 grams. The pizzas cooked at the same elevation above the microwave oven floor, but without the susceptor tray according to the invention, gave a peak force of approximately 650 grams. This illustrates the substantial increase in the positive attribute of firmness and/or crispness due to the presence of the susceptor in accordance with the invention.

### EXAMPLE 2

Testing in accordance with Example 1 was conducted again by the TA-XT2 equipment, but this time while also generating additional data for an oven-baked commercial pizza. The commercial pizza was a DiGiorno cheese pizza intended for oven baking and which was oven baked. The oven-baked pizza had n=1, but n=11 measurements per pizza. Results are reported in FIG. 13.

The firmness and/or crispness, measured as peak force, for the oven-baked cheese pizza was 1100 grams. This illustrates that the microwave-baked pizza, prepared using the susceptor according to the invention, achieved at least the same degree of success in providing these desirable firmness and/or crispness properties as did the oven-baked commercial pizza, both of which were far superior to the about 650 grams of pizzas cooked without the susceptor according to the invention. This illustrates the ability of the present invention to achieve pizza preparation which is at parity with oven baked pizza and which is superior to microwaved pizza not according to the invention.

### EXAMPLE 3

Testing was accomplished concerning the degree of venting or porosity, or lack thereof, provided in the sidewalls or the downwardly extending portions of a susceptor tray as generally shown in FIG. 1 through FIG. 8. Pizzas were placed on susceptors providing a 0.75 inch (19 mm) elevation. During cooking for about 280 seconds, temperature readings were taken at four different locations. One location was at the center of the cheese portion of the pizza. Another location was within the tray volume air space inside the susceptor. A third location was at the center of the interface between the susceptor surface and the pizza. The fourth location was near (and inside of) an edge of the interface between the susceptor surface and the cooking pizza. An average of six measurements was taken at each location.

FIG. 14 plots the average temperature measurement at a multitude of times. These data are an average of six measurements and show the results when substantially zero sidewall porosity was provided, thereby trapping most of the steam generated during cooking within the susceptor volume. These data illustrate the effect of the trapped heated byproduct from the pizza being cooked without any side venting. The air space plot is similar to the central interface plot, especially after about the first minute. The edge interface plot has a slope similar to the central interface plot, thereby illustrating similar heating patterns. These similarities indicate that the platform air space temperature influences cooking at the interface between the susceptor material and the pizza crust. Inasmuch as the plots of these heating patterns are substantially higher in temperature than that of the cheese center, which is not in direct contact with the heated-from-below susceptor, the data illustrate greater heating at the susceptor and at the location of the trapped steam material. There is an approximate 75° F. temperature difference between edge and center temperatures at the crust/susceptor interface at the peak temperature.

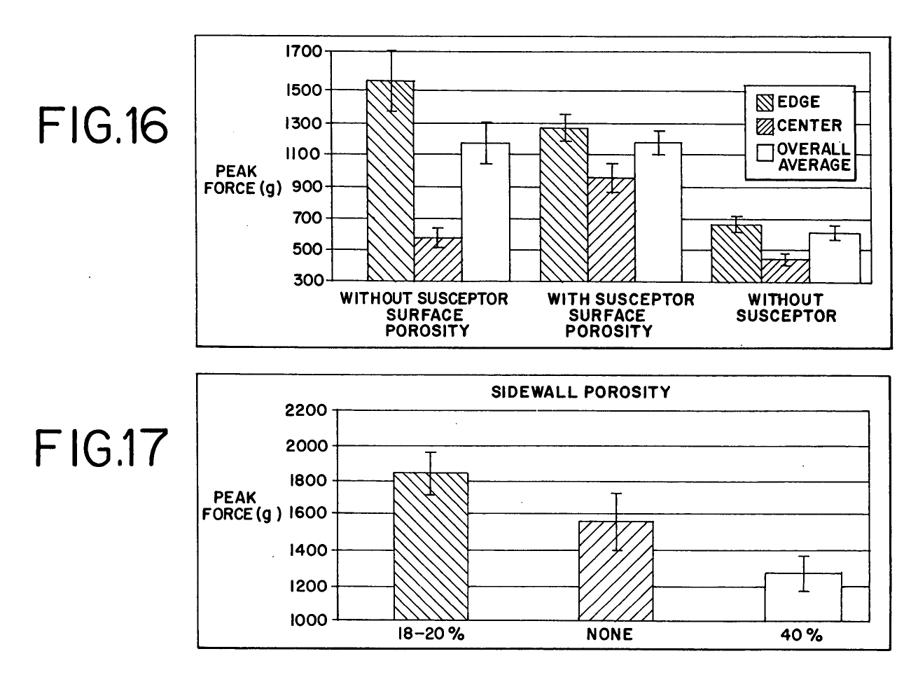

When the sidewall venting was used, a corresponding temperature profile showed only a 16° F. difference in the same peak temperatures, indicating an increased cooking uniformity when side venting is used. The sidewall porosity of these susceptors was 25 percent of the sidewall area. A plot of these data (averages of four measurements) are provided in FIG. 15. This illustrates a key advantage of the sidewall venting application of the invention to achieve increased cooking uniformity of a pizza from center to edge.

### EXAMPLE 4

Tests along the lines of those of Example 3 were conducted. These tests included providing some apertures within the planar portion of the susceptor tray as generally shown in the present drawings. Utilization of the steam generated and trapped within the susceptor tray volume enhances dough or crust center-to-edge cooking uniformity when compared with systems that do not allow formation of steam to a substantial extent. This enhanced uniformity is illustrated by the data plotted in FIG. 15.

Cheese pizzas were prepared and tested generally in accordance with Example 1. Peak force values (shown in FIG. 15) were generated with the TA-XT2 equipment. The standard error includes n=12 (minus outliers) for edge values, and n=3 for center values. However, there were n=5 measurements per pizza and n=3 total pizzas for each plot. In this Example, the apertures through the sidewall extending portion of the susceptor tray of each tray accounted for 7.75 percent of the total area of the sidewall.

The tray having an imperforate susceptor surface showed an excellent firmness and/or crispness, the peak force being in excess of 1500 grams when measured at an edge portion of the pizza. The overall average of in excess of 1100 grams peak force was very good, but the center measurement peak force of about 550 grams showed less than desirable cooking uniformity from center to edge.

Nevertheless, the data of FIG. 15 for the tray having a porous susceptor surface and sidewall porosity were superior to those of the pizzas cooked at the 0.75 inch (19 mm) elevation but without the susceptor tray according to the invention. More specifically, the firmness and/or crispness rating was inferior at all locations for the pizzas cooked without the susceptor surface or susceptor platform holes, even with sidewall porosity. This included the center location.

The enhanced uniformity which is achieved by including venting through the planar susceptor surface of a susceptor according to the invention is illustrated in the center plots of FIG. 15. Thus venting the susceptor surface achieved a much greater uniformity of firmness and/or crispness when compared with the susceptor surface which was not porous, while still providing firmness and/or crispness which was far superior to the pizzas cooked without a susceptor according to the invention.

### EXAMPLE 5

FIG. 16 plots results of testing illustrating enhancements achieved by sidewall susceptor tray venting or porosity. Cheese pizzas were microwaved for 195 seconds within a 1100 Watt Amana household microwave oven. The overall average was n=15; 3 pizzas per measurement, n=5 for each pizza. The pizzas were allowed to set for 2 minutes after microwaving, at which time firmness/crispness were measured using the TA-XT2 unit and texture analysis method as noted in Example 1.

The first (left) bar of FIG. 16 reports peak force readings for a susceptor tray according to the invention which includes a sidewall porosity of about 10 to 15 percent and indicates a peak force of in excess of 1800 grams. The middle bar reports peak force for a susceptor tray which has no sidewall holes and indicates a peak force of in excess of 1500 grams. The last (right) bar shows a large porosity, on the order of 25 to 30 percent, and indicates a peak force of about 1300 grams.

Sensory evaluation resulted in the following observations. The pizzas of the first (left) bar in FIG. 16 were judged as having a crispy texture, dual texture, good texture and crunchy sensory attributes. The pizzas of the second (middle) bar were judged as being more done, more crunchy, darker bottom color, more cooked on their bottoms, slightly overcooked bottom crust, and similar in crispness, all when compared with the pizzas of the first bar. The pizzas of the third (right) bar were judged to be slightly softer, more tender, less hard, and not as crisp as the pizzas of the first bar.

The sensory evaluations illustrate the effect of the sidewall porosity on dough-containing products. They also illustrate that consumer-customizable sidewall porosity has a noticeable affect on cooked pizza attributes, giving the consumer an ability to control cooked crust sensory qualities by varying sidewall openness.

It will be understood that the embodiments of the present invention which have been described are illustrative of some of the applications of the principles of the present invention. Numerous modifications may be made by those skilled in the art without departing from the true spirit and scope of the invention. Various features which are described herein can be used in any combination and are not limited to precise combinations which are specifically outlined herein.

1. A packaged microwave pizza kit, comprising:
a susceptor tray, said tray having a generally planar portion with an inwardly facing face and an outwardly facing face;
a susceptor surface on said outwardly facing face of the susceptor tray;
an extending portion of said susceptor tray which projects generally away from said inwardly facing face and in a direction generally opposite to the direction that the susceptor surface faces;
said extending portion and said inwardly facing face generally define a tray volume location; and
a dough-containing food product adapted to reside within said tray volume location during a packaged, pre-cooking mode of the kit, said dough-containing food product being further adapted to rest upon said outwardly facing face having said susceptor surface during a cooking mode which includes heating of the dough-containing food product by a microwave oven.

2. The kit in accordance with claim 1, wherein said extending portion of the susceptor tray includes a sidewall which downwardly depends with respect to said generally planar portion when said kit is in said cooking mode, and said susceptor tray is thereby adapted to elevate the dough-containing food product above the microwave oven floor and collect heated vapors during the cooking mode.

3. The kit in accordance with claim 2, wherein said extending portion sidewall is substantially imperforate and adapted to substantially retard heated vapor escape from the tray volume location.

4. The kit in accordance with claim 2, further including apertures in said extending portion sidewall in order to provide a porous sidewall adapted to permit outflow of heated vapor from the tray volume location.

5. The kit in accordance with claim 4, wherein said one or more apertures comprise up to about 60 percent of the extending portion sidewall.

6. The kit in accordance with claim 4, wherein said one or more apertures comprise up to about 25 percent of the extending portion sidewall.

7. The kit in accordance with claim 4, wherein said one or more apertures comprise up to about 15 percent of the extending portion sidewall.

8. The kit in accordance with claim 4, wherein said one or more apertures comprise up to about 10 percent of the extending portion sidewall.

9. The kit in accordance with claim 4, wherein said one or more apertures comprise between about 5 and about 30 percent of the extending portion.

10. The kit in accordance with claim 1, further including openings through said generally planar portion of the susceptor tray, said openings being adapted to facilitate passage of heating-generated byproduct including vapor from the dough-containing food product.

11. The kit in accordance with claim 10, wherein said openings are generally uniformly spaced along said generally planar portion of the susceptor tray.

12. The kit in accordance with claim 1, further including a raised boss at the perimeter of said generally planar portion, said raised boss being sized and shaped to accommodate the dough-containing food product during the cooking mode without having the food product overlap the raised boss.

13. The kit in accordance with claim 4, wherein said at least one aperture has an average length which is generally parallel to said susceptor surface and has an average height generally perpendicular to said average length, and said average length is greater than said average height.

14. The kit in accordance with claim 4, wherein said at least one aperture has a majority of its area below a generally vertical center line of said extending portion of the susceptor tray.

15. The kit in accordance with claim 3, wherein said extending portion sidewall includes at least one set of perforations defining a removable perforated area of the otherwise imperforate sidewall, said at least one perforated area adapted to be removed by a user in connection with said cooking mode.

16. The kit in accordance with claim 4, further including at least one perforated area of said sidewall, said perforated area adapted to be removed by a user in conjunction with the cooking mode.

17. The kit in accordance with claim 1, further including at least one perforated area in the generally planar portion of the susceptor tray, said perforated area adapted to be removed by a user in association with the cooking mode.

18. The kit in accordance with claim 11, further including at least one perforated area in the generally planar portion of the susceptor tray, said perforated area adapted to be removed by a user in association with the cooking mode.

19. The kit in accordance with claim 1, wherein said dough-containing food product is a pizza having a crust portion in engagement with said susceptor surface during the cooking mode, the pizza having a topping over the crust member.

20. The kit in accordance with claim 1, further including a secondary packaging member which secures said dough-containing food product within said tray volume location of the susceptor tray during the packaged, pre-cooking mode.

21. The kit in accordance with claim 20, wherein said secondary packaging member is sized and shaped to accommodate said susceptor tray and dough-containing food product therewithin during the packaged, pre-cooking mode of the kit.

22. The kit in accordance with claim 1, wherein said generally planar portion includes openings therethrough that allow for passage of steam from the dough-containing food product during the cooking mode through the openings and into the tray volume location, and wherein said extending portion is sized and shaped to maintain the steam within the tray volume portion to an extent that enhances heat application to the dough-containing food product during the cooking mode.

23. The kit in accordance with claim 22, wherein said dough-containing food portion is a pizza having a dough member in engagement with said susceptor surface during the cooking mode.

24. A microwaveable dough-containing food product kit comprising:
a dough-containing food product having a crust member which is at least partially baked and having edible materials supported by the crust member;
a susceptor tray having a susceptor surface and an extending portion which projects away from and in a direction opposite to the direction that the susceptor surface faces, said extending portion being sized and shaped to elevate the crust member and define an open volume below the susceptor surface;
said susceptor surface has a porosity which permits heated vapor from the food product to pass into the open volume of the susceptor tray; and
said extending portion and said open volume of the susceptor tray and said porous susceptor surface combined to provide said heated vapor in response to the application of microwave energy to the dough-containing food product, whereby enhanced heating of the crust member is effected.

25. The microwaveable kit in accordance with claim 24, wherein said dough-containing food product includes non-dough food components supported by said crust member.

26. The microwaveable kit in accordance with claim 25, wherein said food product is a frozen pizza.

27. The microwaveable kit in accordance with claim 24, wherein said extending portion is substantially imperforate and adapted to substantially retard vapor escape from the tray volume location.

28. The microwaveable kit in accordance with claim 24, further including apertures in said extending portion in order to provide a porous sidewall adapted to permit controlled outflow of heated vapor from the tray volume location.

29. The microwaveable kit in accordance with claim 28, wherein said one or more apertures comprise up to about 50 percent of the extending portion.

30. The microwaveable kit in accordance with claim 28, wherein said at least one aperture has an average length which is generally parallel to said susceptor surface and has an average height generally perpendicular to said average length, and said average length is greater than said average height.

31. The microwaveable kit in accordance with claim 28, wherein said at least one aperture has a majority of its area below a generally vertical center line of said extending portion of the susceptor tray.

32. The microwaveable kit in accordance with claim 28, wherein said extending portion includes perforations defining at least one removable area of the otherwise imperforate extending portion, said at least one removable area adapted to be removed by a user.

33. The microwaveable kit in accordance with claim 24, further including a secondary packaging member which secures said dough-containing food product within said tray volume location of the susceptor tray during a packaged, pre-cooking mode of the kit.

34. A susceptor tray, comprising:
a generally planar portion having an inwardly facing face and an outwardly facing face;
a susceptor surface at said outwardly facing face of the susceptor tray;
an extending sidewall which projects away from and in a direction opposite to the direction that the susceptor surface faces, said extending portion being sized and shaped to maintain said susceptor surface as an elevated platform and to provide an open volume defined by the generally planar portion and the extending sidewall;
said extending sidewall having an open area of not more than 50 percent;
said susceptor tray being adapted to accommodate a dough-containing product within said open volume during a storage mode of the susceptor tray; and
said susceptor tray being adapted to provide a cooking surface for the dough-containing product resting upon said susceptor surface during a cooking mode which includes exposure of the susceptor tray to microwave energy.

35. The susceptor tray in accordance with claim 34, wherein said open area comprises up to about 25 percent of the extending sidewall.

36. The susceptor tray in accordance with claim 34, wherein said open area comprises up to about 10 percent of the extending sidewall.

37. The susceptor tray in accordance with claim 34, further including openings through said generally planar portion of the susceptor tray, said openings being adapted to facilitate passage of steam from the dough-containing food product into the open volume.

38. The susceptor tray in accordance with claim 34, wherein said open area is provided by at least one aperture which has an average length that is generally parallel to said susceptor surface and has an average height generally perpendicular to said average length, and said average length is greater than said average height.

39. A susceptor tray in accordance with claim 38, wherein said at least one aperture has a majority of its area below a generally vertical center line of said extending portion of the susceptor tray.

40. A susceptor tray in accordance with claim 34, further including at least one perforated area which provides a removable aperture of said extending sidewall.
